(19) United States
(12) Patent Application Publication
(10) Pub. No.: US 2005/0083425 A1
(43) Pub. Date: Apr. 21, 2005

(54) Using audio in a customized menu

(76) Inventors: Robert P. Cozier, Fort Collins, CO (US); Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/686,853

(22) Filed: Oct. 16, 2003

(51) Int. Cl. H04N 5/222

(52) U.S. Cl. 348/333.02; 348/207.1; 348/207.2

(57) ABSTRACT

Methods and cameras having a menu that is customized using audio. The camera is configured to have a display and a customizable menu comprising a plurality of selectable items that respectively correspond to selected tasks or actions that may be performed. The camera is configured to have programmable speaking capabilities that comprise preassigned customized descriptors for each of the selectable items. When a particular item is selected, a selected action is performed.

### TECHNICAL FIELD

The present invention relates generally to display systems and methods, and more specifically, to an improved device sharing system having a menu.

### BACKGROUND

Heretofore, a device sharing system has been developed that is employed in digital cameras. The device sharing system has a menu with selectable icons that initiate tasks that are to be performed. The device sharing system for the digital camera allows pictures to be transferred to external devices, specifically to allow printing of pictures and transfer of pictures to specific friends and family, for example.

When an icon is activated, a preprogrammed text string is presented on a display screen of the device that tells the user what action is being taken. However the text string overlays the image on the display screen and blocks the underlying image.

### SUMMARY OF THE INVENTION

The present invention provides for methods and systems in which a menu is customized using audio. The present invention is particularly useful when employed with a digital camera that communicates with one or more external devices that perform tasks relating to images stored in the camera.

An exemplary system comprises a display and a customizable menu that is displayable on the display and which comprises a plurality of selectable items, which may include icons or text, for example, that respectively correspond to selected tasks or actions that may be performed by a user. The system comprises apparatus that provides speaking capabilities and which is programmed with a preassigned text string, or customized descriptor, for each of the selectable items of the menu that represent the respective action performed when a particular item is selected. When a particular item of the menu is selected, the preassigned text string, or customized descriptor, associated with that particular item is spoken or audiblized using the speaking capabilities of the device.

In an exemplary method, a device is configured to have a display and speaking capabilities, and preferably communicates with an external device. The device is configured to have a customizable menu system including a menu that is displayable on the display and which comprises a plurality of selectable items that respectively correspond to selected tasks or actions that may be performed by a user. The customizable menu system is programmed with a preassigned text string, or customized descriptor, for each of the selectable items of the menu that represent the respective action performed when a particular item is selected. When a particular item of the menu is selected, the preassigned text string or customized descriptor associated with that particular item is spoken using the speaking capabilities of the device.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are front and back views, respectively, that illustrate an exemplary embodiment of a digital camera embodying a share system, display system and display method in accordance with the principles of the present invention;

FIG. 2 illustrates an exemplary embodiment of the share system in accordance with the principles of the present invention; and

FIG. 3 illustrates an exemplary method in accordance with the principles of the present invention.

### DETAILED DESCRIPTION

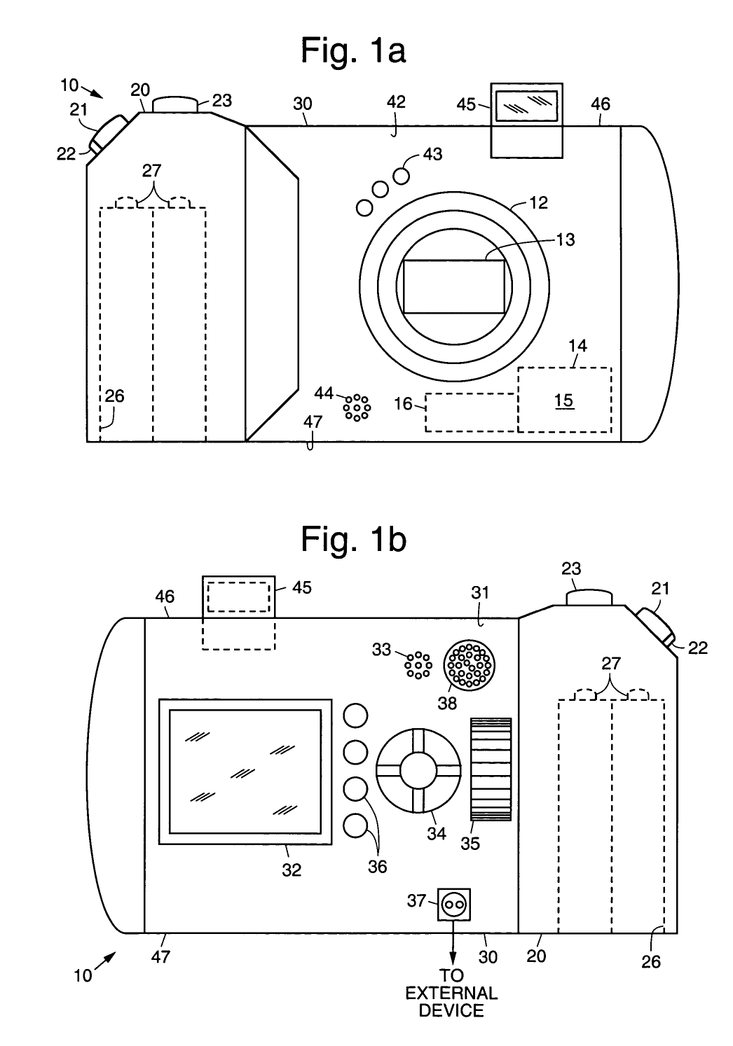

Referring to the drawing figures, FIGS. 1a and 1b show front and back views, respectively, that illustrate an exemplary embodiment of a digital still camera 10 or device 10 that embodies a customizable share system 50 in accordance with the principles of the present invention.

The exemplary digital camera 10 comprises a handgrip section 20 and a body section 30. The handgrip section 20 includes a power button 21 having a lock latch 22, a shutter button 23 (or record button 23), and a battery compartment 26 for housing batteries 27. A metering element 43 and microphone 44 are disposed on a front surface 42 of the digital camera 10. A pop-up flash 45 is located adjacent the top surface 46 of the digital camera 10.

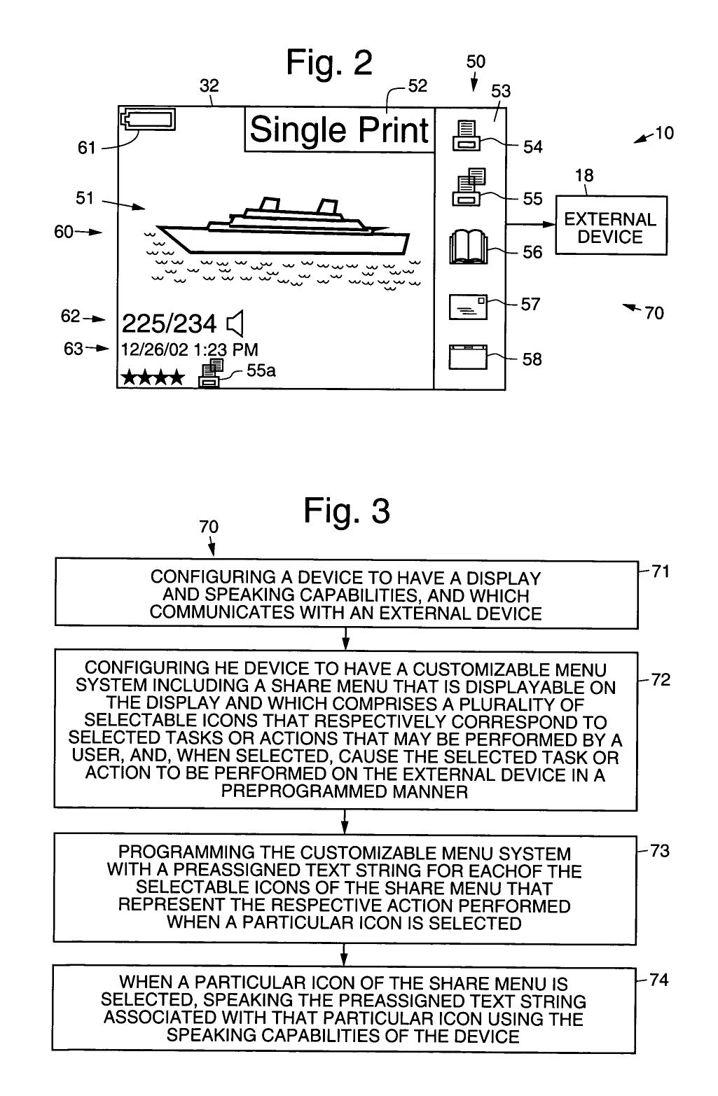

As is shown in FIG. 1b, a rear surface 31 of the exemplary digital camera 10 includes a display 32, such as a liquid crystal display (LCD) 32, for example, a rear microphone 33, a joystick pad 34, a zoom control dial 35, a plurality of buttons 36 for setting functions of the camera 10 and an output port 37 for downloading images 41 (FIG. 2) to an external device 18 (FIG. 2), such as a printer or computer, for example, or to another device 18 by way of the Internet, for example, and a speaker 38.

The digital camera 10 also comprises a lens 12, or imaging optics 12, and an image sensor 13 for receiving images transmitted by the imaging optics 12. A processor 14 is coupled to the image sensor 13 (and other control and input/output components). The processor 14 is also coupled to image memory 16, which may include internal memory 16 and removable memory 16. The processor 14 comprises an algorithm 15 which may be embodied in firmware 15, and that implements the present customizable share system 40 and display method 70.

FIG. 2 illustrates an exemplary embodiment of the customizable share system 50, in accordance with the principles of the present invention. The exemplary customizable share system 50 shown in FIG. 2 comprises a customizable menu 53 that is displayed on the display 32, such as the liquid crystal display (LCD) 32, for example.

The menu 53 includes a plurality of customizable and selectable items 54, 55, 56, 57, 58, which may comprise icons, text, combinations of icons and text, or which may be vocally selected items that are not shown on the display 32. Each of the items 54-58 corresponds to a selected task or action that may be performed with regard to a picture 51 or photographic image 51 that is taken by a user.

With regard to the specific exemplary embodiment shown in FIG. 2, the items 54, 55, 56, 57, 58 shown on the right the menu 53, which appear on the display 32 of the digital still camera 10 in this example, perform multiple operations relating to the external device 18 such as e-mail, print, and send to web, for example. For example, a first icon 54 illustrates a printer icon 54 that is selected to print a single picture 51. A second icon 55 illustrates a printer icon 55 that is selected to print multiple or all pictures 51. A third icon 56 illustrates a book icon 56 that is selected to archive one or more pictures 51. A fourth icon 57 illustrates an envelope icon 57 that is selected to e-mail a picture 51. A fifth icon 58 illustrates a computer desktop icon 58 that is selected to download a picture 51 to a designated computer, for example.

The camera 10 may, however, perform more operations than just these. For example, a camera 10 may connect directly to a printer and execute print selections. Alternatively the camera 10 may connect to a printer and only be configured to show certain actions that are available to the user.

The display 32 of the camera 10 displays the selected picture 51 on which an action or actions are to be taken. The display 32 illustrates a battery 51 that indicates the amount of battery charge that is left. The display 32 shows the number 62 of the picture 51 (225/234). The display 32 also shows the date and time 63 (12/26/02, 1:23. PM) that the picture 51 was taken. In addition, the specific action that is being performed, illustrated as icon 55a, is also shown along with its progress, illustrated by a progression of stars, for example.

FIG. 2 shows an exemplary customized menu 53. A user may scroll up or down and select actions (represented by the items or icons 54-58 for the picture 51 which can be seen in the background of the display 32. These actions are conventionally configured using a personal computer, for example, that is connected to the device 10 or camera 10 during configuration. The present invention allows for customization to take place on the camera 10.

As can be seen in FIG. 2, the relatively limited size of the liquid crystal display (LCD) 32 can impact the usability of the menu 53 and vice versa. Some things can be done to mitigate the overlap of the menu 53 with the background, and resizing the picture 51 is one.

However by resizing the picture 51, it becomes smaller and harder to see. One could also hide the menu 53 in a manner that increases the available screen size for the picture 51, but this limits the usability of the menu 53 which is not desirable.

It is an objective of the present invention to decrease the impact that a screen menu, or in this case a custom menu 53, has on the effective viewing area of the display 32.

In the custom menu system 50 shown in FIG. 2, a user chooses an action type (such as print), and this type then chooses the item or icon 54-58 for the action. Without text associated with the action or icon, the action becomes generic. A print item or icon 54, 55 by itself does not satisfactorily explain that the action is to print a 4×6 photograph locally, for example.

Heretofore, a text string 52 is input by the user using a personal computer to describe the action (“Single Print”, for example) which was displayed when the icon 54-58 was selected. However this solution takes up screen space. A timeout can be used to cause the text string 52 to disappear, but this still leaves the menu 53 taking up space on the display 32.

To overcome these problems and limitations, the present invention provides for a solution that involves the use of customized descriptors 54-58, and in particular, customizable audio, as opposed to text strings 52, to tie the customized descriptors 54-58, such as the icon 54-58, to an action. Rather than showing the text string 52 “Single Print”, the custom menu system 50 enunciates, audiblizes or speaks “4×6” or “4×6 print”, for example, by way of the speaker 38, depending upon how the menu 53 and custom menu system 50 are programmed by the user. For example, the processor 14 may be used to generate the sound from text that has been stored on the camera 10.

It is to be understood that it is not absolutely necessary to employ icons 54-58 in the customizable menu 53. The user interface may employ verbal commands that cause selected tasks or actions to be performed. The user may scroll up and down through the menu 53 and not see any icons 54-58 on the display 32. Selection of the task may be entirely verbal. Alternatively, the menu 53 may include descriptors 54-58 such as small text items or a combination of text and icons 54-58, and is not limited only to icons 54-58.

There are several permutations which will now be discussed. To obtain the absolute maximum screen size, perhaps in a review-mode type operation, for example, which is an operation that occurs when reviewing images already captured and/or stored on the camera 10, the camera 10 or device 10 with the menu 53 could speak all of the share settings currently set for the device 10. In the menu 53 situation above where the user chooses specific items (icon 54-58) the camera 10 may speak each item associated with the icon 54-58 as the menu 53 is scrolled through or when it is brought up. This allows the text strings 52 to be eliminated from the screen and configuration process. The user's vocal statements regarding each of the actions may be programmed into the device 10 at the time of configuration. For example, a processor and/or external chips for voice generation linked to a speaker, or a processor 14 linked to a memory 16 cache (RAM) such that it decodes and generates the signal used by a simple output chip to a speaker, for example, may be used to generate the vocal statements. Alternatively, the text strings 52, or customized descriptors 54-58, can be programmed as done previously, but the processor 14 may be configured to include speech capabilities (a voice chip or processor) so that the text strings 52 (customized descriptors 54-58) are spoken.

FIG. 3 illustrates an exemplary method 70 in accordance with the principles of the present invention. The exemplary method 70 comprises the following steps.

A device 10 is configured 71 to have a display 32 and speaking capabilities, and preferably communicates with an external device 18. The device 10 is configured 72 to have a customizable menu system 50 including a menu 53 that is displayable on the display 32 and which comprises a plurality of selectable items 54-58 that respectively correspond to selected tasks or actions that may be performed by a user. When used in conjunction with the external device, the selectable items 54-58 initiate a through connection with the external device, and, when selected, cause the selected task or action to be performed on the external device in a preprogrammed manner.

The customizable menu system 50 is programmed 73 with a preassigned customized descriptor 54-58, such as a text string (word or phrase) or audio data for each of the selectable items or icons 54-58 of the menu 53 that represent the respective action performed when a particular item or icon 54-58 is selected. When a particular item or icon 54-58 of the menu 53 is selected, the preassigned customized descriptor 54-58 (word or phrase or audio data) associated with that particular item or icon 54-58 is spoken 74 using the speaking capabilities of the device 10.

Thus, methods and systems in which a menu is customized using audio have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A camera comprising:
a display;
a customizable menu that comprises a plurality of selectable items that respectively correspond to selected tasks or actions that may be performed by a user; and
apparatus that provides speaking capabilities and which is programmed with a preassigned customized descriptor for each of the selectable items of the menu that represent the respective action performed when a particular item is selected;
wherein, when a particular item of the menu is selected, the preassigned customized descriptor associated with that particular item is audiblized using the speaking capabilities.

2. The camera recited in claim 1 which communicates with an external device, and wherein the selectable items, when selected, cause the selected task or action to be performed on the external device in a preprogrammed manner.

3. The camera recited in claim 1 which comprises a digital camera.

4. The camera recited in claim 2 wherein the tasks are selected from a group consisting of printing, e-mailing, archiving and downloading data from the system.

5. The camera recited in claim 2 wherein the external device comprises a printer.

6. The camera recited in claim 2 wherein the external device comprises a computer.

7. The camera recited in claim 1 wherein the selectable items comprise icons.

8. The camera recited in claim 1 wherein the selectable items comprise text.

9. The camera recited in claim 1 wherein the selectable items are displayable on the display.

10. A camera for communicating with an external device, comprising:
a display
a customizable menu that comprises a plurality of selectable items that respectively correspond to selected tasks or actions that may be performed by a user, and which initiate a through connection with the external device, and, when selected, cause the selected task or action to be performed on the external device in a preprogrammed manner; and
apparatus that provides speaking capabilities and which is programmed with a preassigned customized descriptor for each of the selectable items of the menu that represent the respective action performed when a particular item is selected;
wherein, when a particular item of the menu is selected, the preassigned customized descriptor associated with that particular item is audiblized using the speaking capabilities.

11. The camera recited in claim 10 which comprises a digital camera.

12. The camera recited in claim 10 wherein the tasks are selected from a group consisting of printing, e-mailing, archiving and downloading data from the system.

13. The camera recited in claim 10 wherein the external device comprises a printer.

14. The camera recited in claim 10 wherein the external device comprises a computer.

15. The camera recited in claim 10 wherein the selectable items comprise icons.

16. The camera recited in claim 10 wherein the selectable items comprise text.

17. The camera recited in claim 10 wherein the selectable items are displayable on the display.

18. A method comprising the steps of;
configuring a device to have a display and speaking capabilities;
configuring the device to have a customizable menu system including a menu comprises a plurality of selectable items that respectively correspond to selected tasks or actions that may be performed by a user;
programming the customizable menu system with a preassigned customized descriptor for each of the selectable items of the menu that represent the respective action performed when a particular item is selected; and
when a particular item of the menu is selected, audiblizing the preassigned customized descriptor associated with that particular item using the speaking capabilities.

19. The method recited in claim 18 wherein the device is configured to communicate with an external device, and wherein the selectable items, when selected, cause the selected task or action to be performed on the external device in a preprogrammed manner.

20. The method recited in claim 18 wherein the device comprises a digital camera.

21. The method recited in claim 18 wherein the tasks are selected from a group consisting of printing, e-mailing, archiving and downloading data from the system.

22. The method recited in claim 19 wherein the external device comprises a printer.

23. The method recited in claim 19 wherein the external device comprises a computer.

24. The method recited in claim 18 wherein the selectable items comprise icons.

25. The method recited in claim 18 wherein the selectable items comprise text.

26. The method recited in claim 18 wherein the selectable are displayable on the display.

27. A camera comprising:
a display;
customizable selection means comprising a plurality of selectable items for performing selected tasks or actions; and
programmable speaking means that provides speaking capabilities and comprises a preassigned customized descriptor for each of the selectable items, for performing a desired action when a particular item is selected.

28. The camera recited in claim 27 wherein, when a particular item is selected, the preassigned customized descriptor associated with that particular item is audiblized using the speaking capabilities.
